(19) United States
(12) Patent Application Publication
(10) Pub. No.: US 2012/0296818 A1
(43) Pub. Date: Nov. 22, 2012

(54) METHOD FOR AUTHORIZING THE ACTIVATION OF A SPENDING CARD

(75) Inventors: Frank Anthony NUZZI, Pflugerville, TX (US); Sridhar Sivaraman, Chennai (IN)

(73) Assignee: eBay Inc., San Jose, CA (US)

(21) Appl. No.: 13/109,257

(22) Filed: May 17, 2011

(51) Int. Cl. G06Q 40/00

(52) U.S. Cl. 705/41

(57) ABSTRACT

A method of authorizing the activation of a card holder's spending card is provided. The method includes receiving a request from the card holder to authorize the activation of the spending card and then requesting identity verification of the card holder. Following the identity verification request, the method includes obtaining a geographic location of the card holder. After determining the geographic location of the card holder, the method may include temporarily activating the deactivated spending card and instructing the card holder to conduct at least one transaction with the spending card at at least one selected location, wherein the selected location is selected based on the geographic location of the card holder. Spending card activity may be monitored to determine whether the at least one transaction was completed, and, based on whether the at least one transaction was completed, the activation of the spending card may be authorized.

### BACKGROUND

1. TECHNICAL FIELD

The present disclosure is related to systems and methods for authorizing the activation of a spending card. In particular, embodiments disclosed herein provide systems and methods for authorizing activation of a spending card by a card issuer for a card holder at any location, and methods and systems for a card holder to request and receive authorization for the activation of a spending card when not at home.

2. Discussion of Related Art

Spending cards, which may include debit or automatic teller machine (ATM) cards, credit cards, gift cards, and electronics benefit transfer (EBT) cards, are becoming a preferred means of conducting transactions. Consumers appreciate the convenience that such spending cards offer over the traditional currency means of conducting transactions, such as cash or personal check. Typically, when a spending card is first obtained by a consumer, the consumer, as a card holder, must contact the card issuer to obtain authorization to activate the card. This is often done by contacting a toll-free number printed on the card, and then entering some additional information, such as the card number and sometimes an identification number associated with the card holder. However, if the spending card is sent to a person other than the card holder, the other person may be able to obtain authorization to activate the spending card and then make fraudulent purchases in the card holder's name. Moreover, if the proper card holder is at a remote location and unable to obtain the necessary information to provide to a card issuer for receiving authorization to activate the spending card, the card holder may be inconvenienced and unable to use the spending card.

When a card holder loses, misplaces, or has a spending card stolen, the card issuer contacts the card issuer and the card issuer takes the usual steps of deactivating the misplaced or stolen spending card and then issuing a new spending card for the card holder. In order to prevent fraud, the new spending card will usually be issued to the card holder's place of business or residence. However, if the card holder is away from their place of business or residence for an extended period of time, they will be unable to receive and use the spending card until they return to their place of business or residence which can be an inconvenience. Moreover, if the card holder later finds the misplaced or stolen spending card, the card holder will still be unable to use the spending card because it has been deactivated and still must wait until they can receive and activate the new spending card before being able to use the card.

What is needed is an improved method and system for authorizing the activation of a spending card which allows for card holders to be able to more reliably and easily request authorization to activate a spending card when they are at a location that is remote from their usual place of business or residence.

### SUMMARY

Consistent with some embodiments, a method of authorizing the activation of a card holder's spending card is provided. The method includes receiving a request from the card holder to authorize the activation of the spending card and then requesting identity verification of the card holder. Following the identity verification request, the method includes obtaining a geographic location of the card holder.

Consistent with further embodiments, there is also provided a method for authorizing the activation of a spending card requesting, using a communication device coupled to a communication network, a card issuer to authorize activation of the spending card and transmitting, using the communication device, identity verification information to the card issuer. The method further includes transmitting, using the communication device, a current geographic location to the card issuer.

Consistent with other embodiments, there is also provided a smart phone comprising a global positioning system (GPS) receiver, a camera, a processor, and a memory, the memory including instructions for execution by the processor that, when executed, instruct the processor to perform a method for requesting the activation of a spending card. The method includes requesting, using the smart phone, a card issuer to activate the spending card, obtaining, using the camera, a digital photograph of the spending card, transmitting, using the smart phone, the digital photograph to the card issuer, and obtaining, using the GPS receiver, a current geographical location. The method further includes transmitting, using the smart phone, the current geographic location to the card issuer.

These and other embodiments will be described in further detail below with respect to the following figures.

### BRIEF DESCRIPTION OF THE DRAWINGS

FIG. 1 is a diagram illustrating a system for use in authorizing activation of a spending card, consistent with some embodiments.

FIG. 2 is a map illustrating a geographic location of card holder, according to some embodiments.

FIG. 3 is a flowchart illustrating a method for authorizing activation of a card holder's spending card consistent with some embodiments.

FIG. 4 is a flowchart illustrating a method for requesting activation of a spending card by a card holder, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

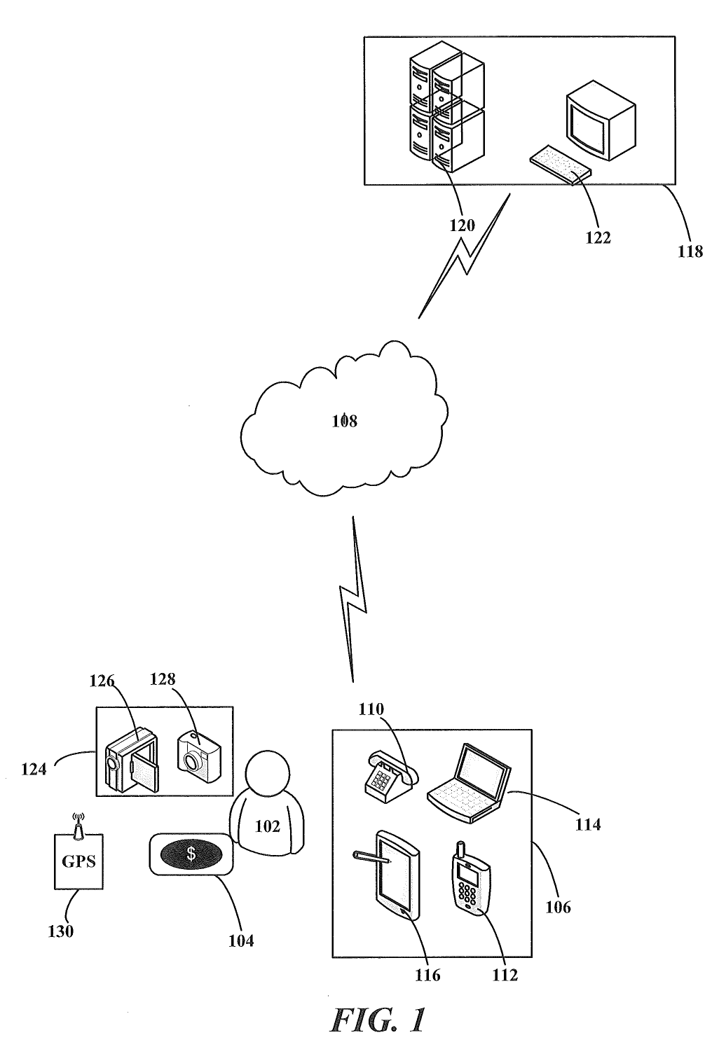

FIG. 1 is a diagram illustrating a system for use in authorizing activation of a spending card, consistent with some embodiments. As shown in FIG. 1, a card holder 102 has a spending card 104. Spending card 104 may be a credit card, a debit/ATM card, an EBT card, a prepaid gift card, or other such card which allows a card holder 102 to use spending card 104 as a substitute for currency in a transaction. Card holder 102 also has a communication device 106 which is coupled to one or more networks 108. Network 108 may include a voice packet network, a data packet network, a combination voice and data packet network, or a standard public switched telephone network (PSTN), and the coupling between communication device 106 and network 108 may be a wired coupling or a wireless coupling. Consistent with some embodiments, communication device 106 may include a standard telephone 110, a smart phone 112, a laptop or personal computer 114, a personal digital assistant (PDA) or a tablet computer 116.

As shown in FIG. 1, a card issuer 118 is also coupled to network 108. In some embodiments, the coupling between card issuer 118 and network 108 may be a wired coupling or a wireless coupling. Card issuer 118 may include one or more servers 120 that store information regarding card holder 102 and spending card 104, and one or more terminals 122 which allow a representative of card issuer 118 to access and view information regarding card holder 102 and spending card 104 and interface with card holder 102. Consistent with some embodiments, card holder 102 may request authorization from card issuer 118 through network 108 to activate spending card 104. In some embodiments, such a request may be for activating a new spending card 104 or reactivation of a deactivated spending card 104. Such a request may be completed by providing to card issuer 118 requisite information such as a card number, an identification number, date of birth, etc., all of which card issuer 118 can verify based on information stored in one or more servers 120. The request and the information may be provided using any form of communication supported by communication device 106 over network 108, such as through a phone call using telephone 110 or smart phone 112, an instant message using laptop or personal computer 114, smart phone 112 or tablet computer 116, a short messaging service (SMS) message using smart phone 112, a video message using smart phone 112, laptop or personal computer 114 or tablet computer 116, or an e-mail or other data message from smart phone 112, laptop or personal computer 114 or tablet computer 116. According to some embodiments, card issuer 118 may have stored in one or more servers 120 contact information for card holder 102, such as one or more phone numbers, an e-mail address, or a screen name. Using the stored contact information, card issuer 118 may contact card holder 102 to request additional information from card holder 102 that will allow card issuer 118 to provide a more secure process for authorizing activation of spending card 104. Additionally, card issuer 118 may be able to monitor the activity of spending card 104 using one or more terminals 122. Such activity may include any transactions made using spending card 104.

According to some embodiments, card holder 102 may have with them camera devices which may act as a visual evidence capture device 124. Visual evidence capture device 124 may include a video camera 126 or a digital or still photographic camera 128. According to some embodiments, visual evidence capture device 124 may be integrated in communication device 106, such as a peripheral attached to or built-in to laptop or personal computer 114, smart phone 112, or tablet computer 116.

Consistent with some embodiments, card issuer 118 may have visual evidence, such as a photograph or video, of card holder 102 stored in one or more servers 120. Consequently, when card issuer 118 receives a request to authorize activation of spending card 104, card issuer 118 may request that card holder 102 transmit visual evidence from visual evidence capture device 124 to card issuer 118 over network 108. Such visual evidence may include a digital photograph or a video of card holder 102 holding spending card 104. The visual evidence of card holder 102 and spending card 104 may then be compared with information regarding card holder 102 and spending card 104 stored in one or more servers 120. Based on a successful comparison between the provided visual evidence and the visual evidence stored in one or more servers 120, card issuer may then authorize the activation of spending card 104 or, if spending card 104 is a deactivated spending card, card issuer 118 may authorize spending card 104 to be reactivated. On the other hand, if a comparison between the provided visual evidence is not successful, card issuer 118 may request additional information from card holder 102 or may simply choose not to activate spending card 104. User verification may be accomplished with other methods as well, including, but not limited to, the user entering a PIN, password, phone number, email address, user name, mailing address, or other identifying information in combination or individually, and/or the user transmitting a biometric identification, such as voice or fingerprint scan.

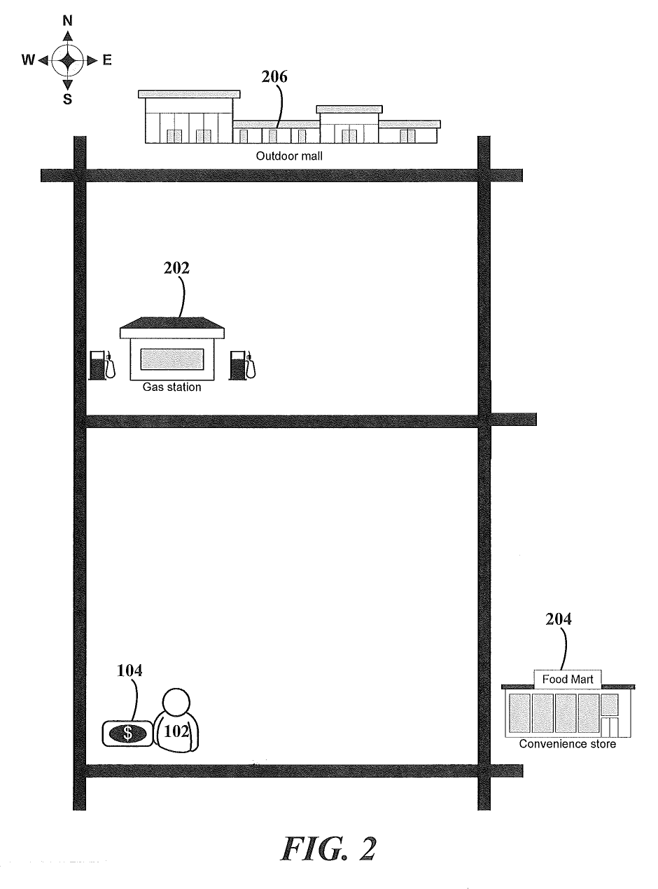

According to some embodiments, card holder 102 may also have a geographic location device 130, such as a global positioning system (GPS)-enabled device, which can provide a precise geographic location of card holder 102. Consistent with some embodiments, geographic location device 130 may be integrated with communication device 106, such as an embedded GPS receiver in, or a peripheral coupled to laptop or personal computer 114, tablet computer 116, or smart phone 112. In other embodiments, geographic location device 130 may be integrated in visual evidence capture device 124 as a GPS receiver embedded in, or coupled to video camera 126 or digital or still photographic camera 128. Such an embedded geographic location device 130 may provide “geotags” for videos and photographs captured with visual evidence capture device 124, by obtaining the precise geographic location that a video or photograph is captured at, and then including the geographic location along with the obtained video or photograph. The geographic location may be stamped as a series of latitude and longitude coordinates on the video or photograph, or may be embedded in metadata associated with a digital video or photograph. The precise geographic location of card holder 102 obtained using geographic location device 130 may be provided to card issuer 118 in order to authorize activation of spending card 104, as will be explained in FIG. 2.

FIG. 2 is a map illustrating a geographic location of card holder 102, according to some embodiments. Upon receiving a precise geographic location of card holder 102, card issuer 118 may temporarily activate spending card 104, and then instruct card holder 102 to conduct one or more transactions with spending card 104 at locations near the geographic location of card holder 102. For example, based on the provided geographic location of card holder 102, card issuer 118 will be able to determine that card holder 102 is near at least three locations, such as gas station 202, convenience store 204, and outdoor mall 206. Card issuer 118 may then instruct card holder 102 to conduct a transaction at, for example, gas station 202 using spending card 104. Such transactions can be very minimal, such as purchasing a pack of chewing gum or a beverage. Card issuer 118 will then monitor the activity of spending card 104 to see if there is a transaction for chewing gum or a beverage, for example, at gas station 202. According to some embodiments, card issuer 118 will place a time limit on to when the transaction must be made, such that the transaction for a beverage or chewing gum is made within a predetermined time. According to other embodiments, card issuer 118 will then instruct card holder 102 to make an additional transaction at convenience store 204, and then at a shop in outdoor mall 206, each having an associated time limit. Moreover, if communication device 106 is a mobile phone such as smart phone 112, card issuer 118 may request that card holder 102 speak with card issuer 118 as the transaction is conducted. According to some embodiments, if card holder 102 is unable to complete a transaction using spending card 104 at any of locations 202, 204, or 206 (for example, if the location does not accept spending card 104 or if the location has a minimum limit for a spending card transaction not met by the suggested transaction, or if the location is closed), card issuer 118 may identify additional locations in a reasonably close proximity to card holder 102 at which card holder can conduct transactions using spending card 104. Alternatively, when identifying locations near card holder 102, card issuer 118 may only identify locations where the suggested transaction will be permitted and accepted.

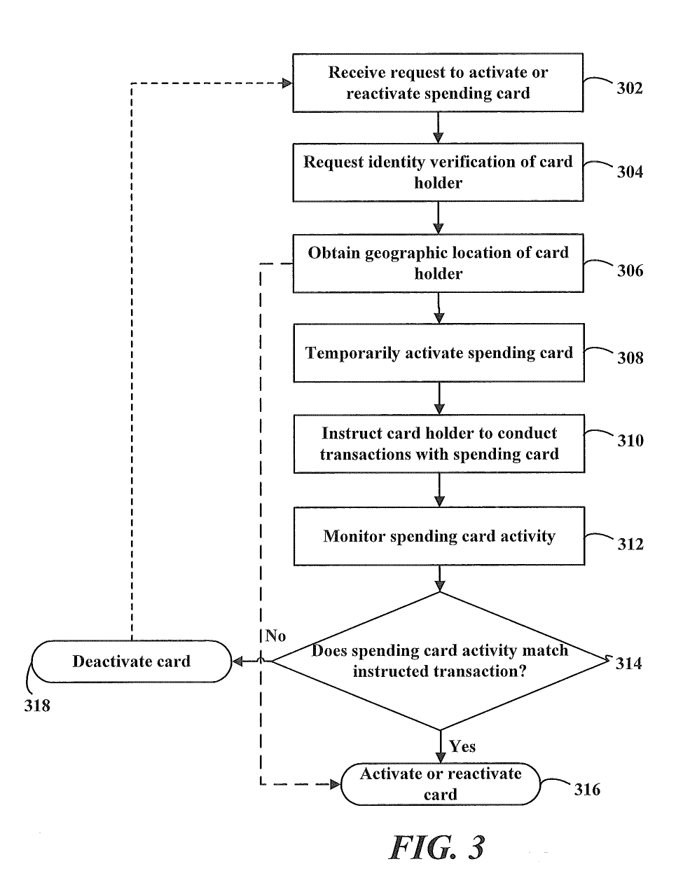

FIG. 3 is a flowchart illustrating a method for authorizing activation of a card holder's spending card consistent with some embodiments. The steps illustrated in FIG. 3 will be described in conjunction with FIGS. 1 and 2. Initially, card issuer 118 will receive a request from card holder 102 using communication device 106 coupled to network 108 to activate a spending card 104 (Step 302). According to some embodiments, the received request may be to activate a new spending card, or to reactivate a deactivated spending card. Upon receiving the request from card holder 102, card issuer 118 may request that card holder 102 verify their identity (Step 304). Consistent with some embodiments, card holder may verify their identity by providing visual evidence to card issuer 118. Such visual evidence may be obtained using visual evidence capture device 124, and may include a photograph or video of card holder 102 holding spending card 104. If the provided visual evidence of spending card 104 and card holder 102 match visual evidence and information of card holder 102 and spending card 104 stored in one or more servers 120 of card issuer 118, card issuer may then obtain the geographic location of card holder 102 (Step 306). The geographic location may be obtained by requesting that card holder 102 provide a geographic location determined using geographic location device 130. Consistent with some embodiments, geographic location device 130 may be integrated with communication device 106, such as an embedded GPS receiver in, or a peripheral coupled to laptop or personal computer 114, tablet computer 116, or smart phone 112. In other embodiments, geographic location device 130 may be integrated in visual evidence capture device 124 as a GPS receiver embedded in, or coupled to video camera 126 or digital or still photographic camera 128. Such an embedded geographic location device 130 may provide “geotags” for videos and photographs captured with visual evidence capture device 124, by obtaining the precise geographic location that a video or photograph is captured at, and then including the geographic location along with the obtained video or photograph. The geographic location may be stamped as a series of latitude and longitude coordinates on the video or photograph, or may be embedded in metadata associated with a digital video or photograph.

Alternatively, if card holder 102 does not have a geographic location device 130, card issuer 118 may obtain the geographic location using other known methods, provided card issuer 118 has the proper permissions to perform such methods. These methods include obtaining the geographic location by tracing the communication made with communication device 106 through cellular tower triangulation or other tracing methods over PSTN, obtaining the Internet protocol (IP) address of communication device 106 such as laptop or personal computer 116, tablet computer 116 or smart phone 112, or obtaining the geographic location from a provide of network 108. In yet other embodiments, card holder 102 may simply provide an address as their current geographic location.

Returning to FIG. 3, after obtaining a geographic location of card holder 102, card issuer 118 may compare the obtained geographic location with a previously known geographic location of card holder 102, such as their home address or work address. If the obtained geographic location matches or relatively corresponds to a previously known location of card holder 102, card issuer may activate of spending card 104 (Step 316).

Consistent with some embodiments, to provide additional security or if the obtained geographic location does not match a previously known location, card issuer 118 may temporarily activate spending card 104 (Step 308). Once spending card 104 is temporarily activated, card issuer 118 may instruct card holder 102 to perform one or more transactions with spending card 102 (Step 310). For example, card issuer 118 may know that from the obtained geographic location of card holder 102 that card holder 102 is within a reasonable distance of gas station 202, convenience store 204, and outdoor mall 206, and instruct card holder 102 to, for example, purchase chewing gum, a beverage, or other relatively inexpensive product from one or more of these locations within a predetermined amount of time. Card issuer 118 may further require that card holder 102 must purchase individual items in a specific order, or use a special number, such as a personal identification number (PIN) when making the instructed transactions, or that card holder 102 use spending card 104 in a particular way, such as using spending card as a debit or credit card. Card issuer 118 may further require that card holder 102 provide expected future transactions in addition to the transactions instructed by card issuer 118. Card issuer 118 will then monitor activity on spending card 104 (Step 312) to determine if the activity on spending card 104 matches the instructed transactions (Step 314). If the activity on spending card 104 matches the instructed transactions, card issuer 118 will be reasonably assured of card holder's 102 identity and activate spending card 104, or reactivate spending card 104 if it had been previously deactivated (Step 316). However, if the activity on spending card 104 does not match the instructed transactions, card issuer will deactivate the temporarily activated spending card 104 (Step 318). At this time, card holder 102 may submit an additional request to card issuer 118 to activate or reactivate spending card 104 (Step 302), which card issuer 118 may evaluate before proceeding.

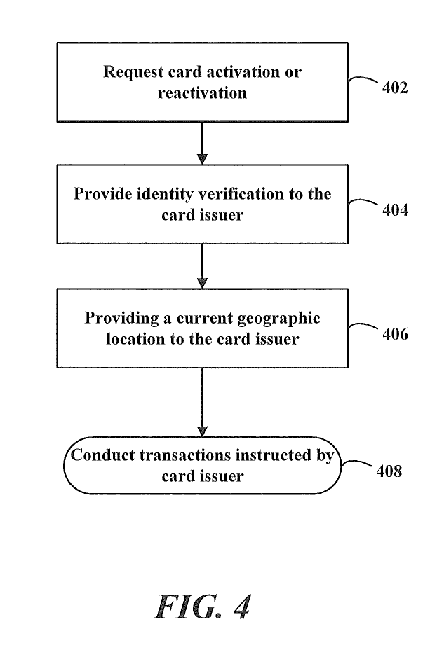

FIG. 4 is a flowchart illustrating a method for requesting activation of a spending card by a card holder, consistent with some embodiments. The steps illustrated in FIG. 4 will be described in conjunction with FIGS. 1 and 2. As shown in FIG. 4, card holder 102 initially requests authorization for activation of spending card 104 by card issuer 118 (Step 402). The request for authorization for activation may be made using communication device 106 over network 108. Card holder 102 may then provide identity verification to card issuer 118 which card issuer can compare with information stored in one or more servers 120 (Step 404). Such identity verification may include personal information such as date of birth, identification numbers, and so forth. According to some embodiments, the personal information may include visual evidence of card holder 102 with spending card 104, which may be a photograph or video of card holder 102 with spending card 104 obtained using visual evidence capture device 124, as discussed herein. After providing suitable verification of their identity, card holder 102 may then provide a current geographic location to card issuer 118 (Step 406). As discussed herein, the current geographic location may be provided using geographic location device 130. Consistent with some embodiments, geographic location device 130 may be integrated with communication device 106, such as an embedded GPS receiver in, or a peripheral coupled to laptop or personal computer 114, tablet computer 116, or smart phone 112. In other embodiments, geographic location device 130 may be integrated in visual evidence capture device 124 as a GPS receiver embedded in, or coupled to video camera 126 or digital or still photographic camera 128. Such an embedded geographic location device 130 may provide “geotags” for videos and photographs captured with visual evidence capture device 124, by obtaining the precise geographic location that a video or photograph is captured at, and then including the geographic location along with the obtained video or photograph. The geographic location may be stamped as a series of latitude and longitude coordinates on the video or photograph, or may be embedded in metadata associated with a digital video or photograph. Alternatively, card holder 102 may simply provide an address as their current geographic location. Consistent with some embodiments, if card issuer 118 determines that the provided geographic location matches a previously known location, card issuer 118 may proceed to activate spending card 104.

Consistent with some embodiments, to provide additional security or if the obtained geographic location does not match a previously known location, after providing a current geographic location to card issuer 118, card holder 102 then may perform one or more transactions according to instructions from card issuer 118 based on the current geographic location (Step 408). For example, card issuer 118 may know that from the provided geographic location of card holder 102 that card holder 102 is within a reasonable distance of gas station 202, convenience store 204, and outdoor mall 206, and instruct card holder to, for example, purchase chewing gum, a beverage, or other relatively inexpensive product from one or more of these locations within a predetermined amount of time. Card holder 102 will then conduct these transactions according to the instructions of card issuer 118 (Step 408), and card issuer 118 will then monitor activity on spending card 104 to determine of the activity on spending card 104 matches the instructed transactions. Based on this monitoring, card issuer 118 will decide on whether to grant or deny card holder's request for activation of spending card 104.

As noted herein, communication device 106 may have visual evidence capture device 124 and geographical location device 130 either integrated therein or operatively coupled thereto. Consequently, communication device 106 may be operable to automatically perform steps 402-406 of FIG. 4. For example, communication device 106 may be a modern smart phone 112 which includes a user interface, a camera corresponding to visual evidence capture device 124, and a GPS receiver corresponding to geographical location device 130. Smart phone 112 may further include a processor and a memory which includes instructions for execution by the processor. The instructions may correspond to programming or an application that, when executed by the processor, cause the processor to perform a series of steps, such as steps 402-406 of FIG. 4. For example, the instructions may transmit a request to card issuer for authorization for activation of spending card 104. The request may be a data request sent over a data packet network, such as network 108. Alternatively, the instructions may cause the processor to instruct smart phone 112 to initiate a phone call with card issuer 118. Moreover, the instructions may cause the processor to instruct smart phone 112 to capture a digital photograph or video of card holder 102 with spending card 104, and then transmit the digital photograph or video of card holder 102 with spending card 104 over data network, such as network 108. Furthermore, the instructions may cause the processor to instruct smart phone 112 to obtain a current geographical location of card holder 102 using an embedded GPS receiver, and then transmit the current geographical location to card issuer 118 either as separate data, or as metadata associated with the digital photograph or video of card holder 102 with spending card 104. According other embodiments, smart phone 112 may receive instructions from card issuer 118 over a data network such as network 108 which include locations for conducting the instructed transactions. The memory of smart phone 112 may include instructions for displaying the locations using a map function or application of smart phone 112, which provides assistance to card holder 102 in completing step 408 of FIG. 4. Although the example given herein is for a smart phone, steps 402-406 of FIG. 4 may be automatically enabled on any device having a memory for storing the necessary instructions for execution by a processor, and having either integrated in, or operatively coupled thereto, visual evidence capture device 124 and geographical location device 130.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, it is contemplated that software components may be implemented as hardware components and vice-versa.

Software, in accordance with the present disclosure, such as program code and/or data, may be stored on one or more computer readable mediums, including non-transitory computer readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein

Consequently, embodiments as described herein may provide an improved method for authorizing activation of a spending card by a card issuer that provides increased security by requiring visual evidence of a card holder with the spending card and requiring the card holder to conduct one or more designated transactions at locations selected according to the card holder's selected location. Embodiments provided herein may also provide an improved method for card holders to request authorization of activation of a spending card that allows for the card holder to request activation or even reactivation anywhere that the card holder may be. Furthermore, embodiments provided herein may take advantage of the capabilities of smart phones and other all-in-one devices to provide a card holder a way to request authorization for activation or reactivation of a spending card using visual geographical location capture capabilities of these devices to provide sufficient verification evidence to a card issuer for activation or reactivation of a spending card. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A method of authorizing the activation of a card holder's spending card, comprising:
receiving a request from the card holder to authorize the activation of the spending card, the request being initiated from a communication device of the card holder coupled to a network;
requesting identity verification of the card holder; and
obtaining a geographic location of the card holder.

2. The method of claim 1, further comprising:
determining whether the obtained geographic location matches a known location of the card holder; and
authorizing the activation of the card holder's spending card if the obtained geographic location matches a known location of the card holder.

3. The method of claim 1, further comprising:
temporarily activating the deactivated spending card;
instructing the card holder to conduct at least one transaction with the spending card at least one selected location, wherein the selected location is selected based on the geographic location of the card holder;
monitoring spending card activity;
determining, based on the monitored spending card activity, whether the at least one transaction was completed; and
determining, based on whether the at least one transaction was completed, whether to authorize the activation of the spending card.

4. The method of claim 1, wherein receiving a request from the card holder comprises at least one of:
receiving a phone call from the card holder;
receiving a short messaging service (SMS) message from the card holder;
receiving an instant message sent over a network from the card holder;
receiving a video message sent over the network from the card holder; and
receiving the request over the network as data packets transmitted by an application stored in a memory of the communication device and being executed by a processor of the communication device.

5. The method of claim 1, wherein requesting identity verification of the card holder comprises:
requesting visual evidence of the card holder with the spending card; and
receiving the visual evidence over the network.

6. The method of claim 1, wherein obtaining a geographic location of the card holder comprises obtaining the geographic location from the communication device.

7. The method of claim 6, wherein obtaining the geographic location from the communication device comprises at least one of:
obtaining the geographic location by tracing a global positioning system (GPS) receiver in the communication device; and
requesting that the card holder transmit the geographic location over the network.

8. The method of claim 7, wherein obtaining the geographic location from the communication device comprises obtaining the geographical location as metadata embedded in a digital photograph received from the card holder in response to the request for identity verification.

9. The method of claim 1, wherein the communication device comprises at least one of a smart phone, a camera, a tablet computer, a netbook, a personal computer, a telephone, and a laptop computer, and the network comprises at least one of a wired data packet network, a wireless data packet network, a wireless voice packet network and a wired voice packet network.

10. The method of claim 1, wherein:
the communication device comprises a smart phone and receiving a request from the card holder comprises at least one of:
receiving a phone call from the card holder using the smart phone;
receiving a short messaging service (SMS) message from the card holder using the smart phone;
receiving an instant message over the network from the card holder using the smart phone;
receiving a video message over the network from the card holder using the smart phone; and
receiving the request over the network initiated by an application stored in a memory of the smart phone and being executed by a processor of the smart phone.

11. A method for requesting the authorization of the activation of a spending card, comprising:
requesting, using a communication device coupled to a communication network, a card issuer to authorize activation of the spending card;
transmitting, using the communication device, identity verification information to the card issuer; and
transmitting, using the communication device, a current geographic location to the card issuer.

12. The method of claim 11, further comprising:
receiving, using the communication device, instructions for conducting at least one transaction using the spending card at at least one selected location, the at least one selected location being selected based on the current geographic location.

13. The method of claim 11, wherein requesting a card issuer to authorize activation of the spending card comprises at least one of:
making a phone call to the card issuer;
sending a short messaging service (SMS) message to the card issuer;
sending an instant message over a network to the card issuer;
sending a video message over the network to the card issuer; and
transmitting the request over the network, the request being initiated by an application stored in a memory of the communication device and being executed by a processor of the communication device.

14. The method of claim 11, wherein transmitting identity verification information comprises:
obtaining visual evidence of the spending card; and
transmitting the visual evidence to the card issuer using the communication device.

15. The method of claim 11, wherein transmitting a current geographical location to the card issuer comprises:
determining the current geographical location using a global positioning system (GPS)-capable device; and
transmitting the current geographical location using the communication device.

16. The method of claim 11, wherein the communication device is a smart phone having a global positioning system (GPS) receiver and a digital camera, and wherein:
requesting a card issuer to authorizing activation of a spending card comprises contacting, using the smart phone, the card issuer;
transmitting identification information to the card issuer comprises taking a digital photograph of the spending card using the digital camera of the smart phone, and transmitting the digital photograph to the card issuer using the smart phone; and
transmitting a current geographical location to the card issuer comprises determining the current geographical location using the GPS receiver of the smart phone and transmitting the geographical location using the smart phone.

17. The method of claim 16, wherein the current geographical location is embedded in metadata of the digital photograph.

18. The method of claim 16, wherein requesting a card issuer to authorize activation of the spending card comprises at least one of:
making a phone call to the card issuer using the smart phone;
sending a short messaging service (SMS) message to the card issuer using the smart phone;
sending an instant message over a network to the card issuer using the smart phone;
sending a video message over the network to the card issuer using the smart phone; and
transmitting the request over the network, the request being initiated by an application stored in a memory of the smart phone and being executed by a processor of the smart phone.

19. The method of claim 11, wherein the communication device comprises one of a smart phone, a camera, a tablet computer, a netbook, a personal computer, a telephone, and a laptop computer.

20. A smart phone comprising a global positioning system (GPS) receiver, a camera, a processor, and a memory, the memory including instructions for execution by the processor that, when executed, instruct the processor to perform a method for requesting the activation of a spending card, comprising:
requesting, using the smart phone, a card issuer to activate the spending card;
obtaining, using the camera, a digital photograph of the spending card;
transmitting, using the smart phone, the digital photograph to the card issuer;
obtaining, using the GPS receiver, a current geographical location; and
transmitting, using the smart phone, the current geographic location to the card issuer.

21. The method of claim 21, further comprising:
receiving, using the smart phone, instructions for conducting at least one transaction using the spending card at at least one selected location, the at least one selected location being selected based on the current geographic location.

22. The method of claim 20, wherein the current geographic location is embedded in metadata of the digital photograph.

23. The method of claim 20, wherein requesting a card issuer to reactivate the deactivated spending card comprises at least one of:
making a phone call to the card issuer using the smart phone;
sending a short messaging service (SMS) message to the card issuer using the smart phone;
sending an instant message over a network to the card issuer using the smart phone;
sending a video message over the network to the card issuer using the smart phone; and
transmitting the request over the network.

24. The method of claim 21, wherein receiving instructions for conducting at least one transaction using the spending card at at least one selected location comprises:
receiving instructions for conducting transactions at a plurality of locations, the instructions providing a predetermined order in which to conduct the transactions; and
receiving, by the smart phone, the geographical locations of the plurality of locations.
